(19) United States
(12) Patent Application Publication
(10) Pub. No.: US 2007/0234643 A1
(43) Pub. Date: Oct. 11, 2007

(54) Spring-Assisted Mechanism for Raising and Lowering a Load

(76) Inventors: Burton L. Siegal, Skokie, IL (US); Joseph V. Ambrose, Bradenton, FL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/734,148

(22) Filed: Apr. 11, 2007

Related U.S. Application Data
(60) Provisional application No. 60/790,880, filed on Apr. 11, 2006.

(51) Int. Cl. E05D 15/48

(52) U.S. Cl. 49/360; 49/169

(57) ABSTRACT

An apparatus for selectively raising, lowering or otherwise moving load such or panel, or other article such as a pet door comprises a frame, a panel, a motor, a constant tension spring, and a control system. The panel is carried by the frame for movement between an open position and a closed position. The spring is attached to the panel to bias the panel open. The frame includes a plurality of groves retaining seals such as fibrous weatherseal to seal the interface between the panel and the frame against penetration by the elements. The control system is in communication with the motor to actuate the motor, thereby moving the panel with the assistance of the spring. The control system includes an antenna in the panel for emitting a low frequency (RFID) signal, and a fob that is worn by a pet to communicate with the antenna to actuate the motor.

### CROSS-REFERENCE TO RELATED APPLICATIONS

The present application is based on and claims the benefit of priority of U.S. Provisional Patent Application No. 60/790,880, filed Apr. 11, 2006, the entire contents of which are hereby expressly incorporated herein by reference.

### BACKGROUND OF THE INVENTION

Currently, various systems are available for providing powered opening and closing of doors such as pet doors, and raising, lowering or otherwise moving loads or articles in point-of-purchase displays and the like, or even for raising and lowering loads or articles such as projector screens, chalkboards, dumb-waiter doors, plasma and LCD televisions, for example. Typically, these systems include a motor and a pulley assembly. Depending on the size and weight of the article requiring lifting, the motor can tend to be relatively large and expensive.

One example of a market wherein various alternative solutions to opening and closing doors, for example, exist, is the pet door industry. The great need for pet owners to allow their pets to enter and exit the home without the assistance or even the presence of a family member is made even more evident by the wide range and number of devices that are and were in the past, commercially available in an effort to address this need. A pet door that can accommodate the owner's pet can also allow a neighbor's pet or even a stray animal access to the home. Far worse, it can allow a rodent, squirrel or raccoon access to the interior of the home. Larger pet doors could allow access to a burglar or worse.

Existing pet doors have gotten progressively more sophisticated beginning with simple flexible plastic flaps that are hung from their top or sides. The better of these have magnets on their edges in an attempt to reduce the wind infiltration. Next are rigid plastic doors hinged from either the top or sides of the door and the best of these have fibrous sealing strips on their edges to try and withstand the wind infiltration. However, in keeping the closing force down to where a dog's face could overcome it, a relatively mild wind could cause infiltration of cold air and rain.

A much more sophisticated structure for a pet door is characterized by a motor driven, sliding panel as disclosed by U.S. Pat. No. 5,177,900 to Solowiej. Solowiej employs a battery powered, transmitting device on the pet's collar that sends a coded signal to a receiver on the door to cause it to open. Solowiej, however, has certain deficiencies. The mechanism is powered to raise the door and gravity lowers the door. Specifically, gravity enables the mechanism to bring the door downward to close it creating a slow moving, but forceful guillotine that could injure or sever the tail of a pet lingering in the opening. In addition, the electronics could be damaged by dangling into a water dish while a pet takes a drink.

While the Solowiej panel rides within channels in side walls, Solowiej provides nothing to resist the infiltration of wind and moisture. Lubricant placed in the channels to assist smooth, even motion of the panel attracts dirt, become attached to the sides of the pet and may often be transferred to the fabric of the furniture on which the pet later rests. Further, the Solowiej device is bulky and thick. While the opening in the outer wall of the home is acceptably not much bigger than the door opening for the pet, the very large, full height cavity required to mount it between the studs may be acceptable in a wall, but it would be difficult to hang on a door. A further shortcoming of the commercialized version of this device is the fact that placed between the existing standard spaced studs of a wall, its vertical side walls restrict the width of the available opening such that the maximum size dog would be about 90 pounds in weight. A version that could accommodate a larger dog would require removing a portion of one of the wall's studs, creating a substitute structural support spaced wider than the standard 16″ center spacing and repairing the wall surfaces that would be damaged in accomplishing this. With a 120 volt AC line voltage power cord coming out of its bottom, it is a potentially dangerous thing on a swinging door, particularly so if the cord exits on the side furthest from the door's hinges.

Others have recognized the shortcomings of a battery powered identification transmitter on the pet's collar and attempted to overcome it. De La Certa et el in U.S. Pat. No. 5,992,096 and later Small in U.S. Pat. No. 6,297,739 B1 disclose the use of an unpowered, coded identification tag worn by the pet. In their case, it could even be a small capsule that may be implanted under the skin of an animal for pet and owner identification. This technology falls within the scope of Radio Frequency Identification, RFID. In this technology, small coded tags require high frequency interrogation radio frequency beams to get a response. In general, the higher the frequency and power, the greater the range. While this is very desirable for the main stream application of RFID, i.e., inventory control and identification, it is not a preferable method to be applied to the operation of a pet door. The problem is that with greater range, the pet door will be actuated repeatedly every time the pet passes or remains within range of the transmitter which can be a few yards or more. To deal with this problem, additional means have been employed to identify when the pet was in close proximity to the pet door before actuating the interrogation beam. These means employed to establish this close proximity included such things as ultra-sonic ranging devices and a weight sensor adjacent to the pet door.

The fact that one dog alone can often exceed 100 operations per day attending to hygienic needs but also investigating the presence of birds, rabbits, squirrels, passing pedestrians and trucks, etc. requires great durability, simplicity and cost effectiveness in any pet door that addresses these various objectives and intends to be commercially viable. The common situation of a household with two pets sharing the device, nearly doubles the severity of the duty cycle. A further shortcoming of the Solowiej device and others that allow the gear motor to run at full power into a solid stopping of the door is that hundreds of thousands of such sudden stops will occur with the same gear teeth engaged subjecting them and the fastening means between the gears and their shafts to endure a duty cycle that should promote premature failure.

### SUMMARY OF THE INVENTION

One aspect of the present invention provides an apparatus for selectively raising and lowering a load. In one embodiment, the load may be a panel that serves as a pet door, for example. The apparatus comprises a base structure, the panel, a gear motor, a constant tension spring, and a control system. The panel is carried by the base structure for movement between an open position and a closed position. The motor is also carried by the base structure and has an output shaft. The constant tension spring includes a first end and a second end. The first end of the spring is attached to one of the output shaft of the motor and the base structure. The second end of the spring is attached to the panel. The spring biases the panel into the open position. The control system is in communication with the motor to actuate the motor and rotate the output shaft, thereby moving the panel from the closed position to the open position with the assistance of the spring.

Another embodiment of the present invention utilizes an unpowered, programmable radio frequency identification device (RFID) on the pet's collar and a scanning control device that detects the desired code and causes a control system to open and close the door.

Still another embodiment of the present invention includes a programmable pet door system that provides a vertically rising door that may be sealed against the elements by low friction, fibrous seals on one or more of its edges which may also serve to guide the door's panel through its motion. The panel may be raised by a gear motor which may have a constant tension spring mounted on its output shaft. An extended end of the constant tension spring may engage a lever which may be mounted on the upper end of the panel. The upper end of the panel may also contain a spring loaded latch that may engage an opening in a frame of the device to securely lock the panel in the generally closed position. The latch may be withdrawn from engagement by a link between it and the lever in a manner such that the latch may be fully withdrawn before the additional pull on the constant tension spring causes the panel to move upward. The frame may be configured to maintain the movable panel, its seal strips, the gear motor, the control panel, the latching means and the constant tension spring all inside the plane of the inner wall of the enclosure that the pet door serves. This configuration may be further optimized by confining all the large, horizontally thick members of the mechanism such as the gear motor and its mounted constant tension spring centrally located at the top of the structure which may enable a relatively compact cover to contain and conceal them and removably attach to a thin cover panel that may conceal the balance of controls and mechanism above the opening for the pet. This embodiment can result in an attractive, relatively thin housing on the inside of the wall or door and a small opening through the wall or door that is slightly larger than the net opening of the pet door.

In one embodiment, the seals strips may engage the entire perimeter of the outward face, the sides and bottom of the inward face and both vertical edges and the bottom edge of the door panel. In one embodiment, the cover panel may be made of a relatively thin, but of a stiff and strong material with edges confined in a channel spaced inwardly from the door panel. The cover panel may be fastened in place in the normal, uppermost location with its lower edge above the uppermost opening for the pet to pass through. The cover panel may be unfastened and lowered for access to the mechanism and controls or may be fastened in the fully down location to provide additional security to supplement the latched door panel during periods of prolonged disuse such as during a vacation or for hurricane protection.

While this pet door fully contemplates the use of an AC gear motor, in one embodiment, a low voltage DC gear motor may be used which may be supplied by a remote, plug-in power supply having an output current that may be purposely below the full power requirement of the gear motor. The control circuit may provide one or more capacitors which are fully charged by the power supply between opening cycles. Upon the gear motor being energized by the control, it may be fully powered by both the discharge of the capacitor and the power supply and aided by the constant tension spring, it vigorously unlatches and begins pulling the door panel upward. The capacitor may be sized so that it may be exhausted before the panel reaches the fully open position, such that the output of the undersized power supply alone drives the panel its final distance. This reduced power level may be little more than enough to maintain the panel in the full open position. When the dwell period, which may be adjustable, expires, the power is cut to the gear motor and the weight of the panel overcomes the pull of the constant tension spring and the frictional resistance of the sealing strips. This causes the panel to slowly descend against the bias of the spring, back winding the gear motor and eventually bottoming out with a net force of a few ounces which is less than what might cause injury or for that matter even pain to a lingering pet. This configuration therefore advantageously eliminates the need for sensors or other protective devices to prevent pinching when the load bottoms out. The use of the capacitor that is fully charged shortly after each operating cycle may provide an important additional benefit. RFID electronics require a D.C. power supply with a relatively low ripple. Another embodiment may eliminate the use of power capacitors and utilize a power supply of adequate capacity to fully power the motor in the upward direction and in a manner that is disclosed below, powering it in a down direction with a reduced voltage. So configured, the system may include a programmable micro-processor and one or more switches such as reed switches for detecting when the panel reaches a full open position, for example.

The use of a DC gear motor allows the use of a dynamic braking resistor across its leads to supplement the drag of the sealing strips and the gear train when the power is cut to the gear motor and the panel is descending. The amount of resistance may be adjustable which would create the opportunity to compensate for the change in frictional resistance of the sealing strips due to long term wear or the effects of severe changes in weather.

The device may have one or more jacks in its frame that may receive a mating plug and power cord coming from the plug-in power supply. Withdrawal of the plug provides for instant disablement of the device for either a vacation mode or in the event of a malfunction. An audible signaling device may be incorporated to alert an owner, who may be a distance from the device, that it has been actuated. One or more indicator lights may be incorporated to indicate that the power is on and/or that the device has detected a properly coded tag.

The identification of a pet carrying the proper coded tag is accomplished by what is characterized as a low frequency system which is generally accepted to operate in the vicinity of between approximately 90 KHz and approximately 200 KHz, and at least in one embodiment approximately 134 KHz. Its short range makes it ideal for the application of a pet door, which ideally would be in the general distance of between approximately 10 inches and approximately 30 inches, and, at least in one embodiment, between approximately 10 inches and approximately 18 inches, and in another embodiment between approximately 18 inches and 24 inches.

Additionally, this pet door may have an alternately positioned antenna within the opening in the door or wall of the enclosure without restricting the pet's ability to pass through the opening. It may alternatively employ a cylindrical ferrite type antenna in the upper most portion of the opening or a coiled antenna which may be laminated within the vertical moving panel of the device or bonded onto one of the panel's surfaces.

In at least one embodiment, the ability for the non-technical home owner to troubleshoot and repair the device may be greatly enhanced. A manual press to operate switch may be provided to determine if a failure to operate is due to the pet detection control or the power and gear motor portion. The cover protecting and concealing the large protruding components may be a snap fit for quick and easy removal which could expose at least a single fastener which if removed, would allow the cover panel to be lowered exposing all of the controls and mechanism. The sliding door and the sliding cover panel, which can be located inside the plane of the surface of the inside wall or door, may be removed and replaced by merely removing the top cap of the device's frame.

These and other features will become more apparent as the drawings and the detailed description of the invention are studied.

### BRIEF DESCRIPTION OF THE DRAWINGS

FIG. 1 is a partial sectional perspective view of one embodiment of a raising and lowering apparatus constructed in accordance with the principles of the present invention and constituting a pet door device mounted in a wall;

FIG. 2 is an elevation view of the device in the closed mode, mounted in a wall and viewed from the inside;

FIG. 3 is a cross-sectional view of Section A-A taken through FIG. 2 with the device in the maximum open mode;

FIG. 4 is a cross-sectional view of Section B-B taken through FIG. 2 if the device were mounted in a door;

FIG. 5 is an enlarged cross-sectional view of Section C-C taken through FIG. 4;

FIG. 6 is a partial cross-sectional view of Section D-D taken through FIG. 5;

FIG. 7 is an elevation of the device mounted in a door in a vacation mode, or hurricane mode.

FIG. 7a is an enlarged portion of FIG. 7;

FIG. 8 is an enlarged cross-sectional view of two of the sectional segments of FIG. 4;

FIG. 9 is an enlarged cross-sectional view of a portion of FIG. 5;

FIG. 10 is an enlarged front plan view of an upper portion of FIG. 7;

FIG. 11 is an enlarged view of a middle portion of FIG. 7;

FIG. 12 is an enlarged break-out view of FIG. 11;

FIG. 13 is an illustration similar to FIG. 12;

FIG. 14 is an enlarged portion of FIG. 13;

FIG. 15 is a partial view of a top frame member of the device when removed for access to its vertical panels;

FIG. 16 is an elevation of the device in the closed mode with an alternative antenna;

FIG. 17 is a cross-sectional view of Section E-E taken through FIG. 16;

FIG. 18 is a cross-sectional view of Section F-F taken through FIG. 16;

FIG. 19 is an enlarged cross-sectional view of an upper portion of FIG. 17;

FIG. 20 is an enlarged cross-sectional view of a lower portion of FIG. 17;

FIG. 21 is an enlarged cross-sectional view of a portion of FIG. 18;

FIG. 22 is an electrical schematic of the device;

FIG. 23 is an alternative electrical schematic of the device; and

FIG. 24 is a partial sectional perspective view of an alternative embodiment of a raising and lowering apparatus constructed in accordance with the principles of the present invention and constituting a pet door device mounted in a wall.

### DETAILED DESCRIPTION

For the purpose of promoting an understanding of the principles of this invention, reference will now be made to the embodiments illustrated in the drawings and specific language will be used to describe the same. It will be nevertheless understood that no limitation of the scope of the disclosure is thereby intended. The disclosure includes any alterations and further modifications in the illustrated devices and described methods and further applications of the principles of the disclosure that would normally occur to one skilled in the art to which this disclosure relates.

The present disclosure describes a spring-assisted mechanism for raising and lowering a load. The disclosed embodiment includes a pet door. However, the device may similarly be incorporated into other systems such as, for example, point-of-purchase advertising components or any other system requiring such a mechanism. The pet door of the disclosed example may easily be installed in the door or wall of a pet owner's or pet service facility's enclosure. It employs a coded, passive electronic tag preferably attached to the pet's collar that has a code that may be specific to that pet or to all the pets owned or in their care. The electronic technology employed is commonly described as Radio Frequency Identification or RFID. The parameters of its operation may easily be adjusted and all of its components easily repaired or replaced. The present disclosure further protects the safety of the pet and the security of the enclosure from both the weather and intruders, animal or human.

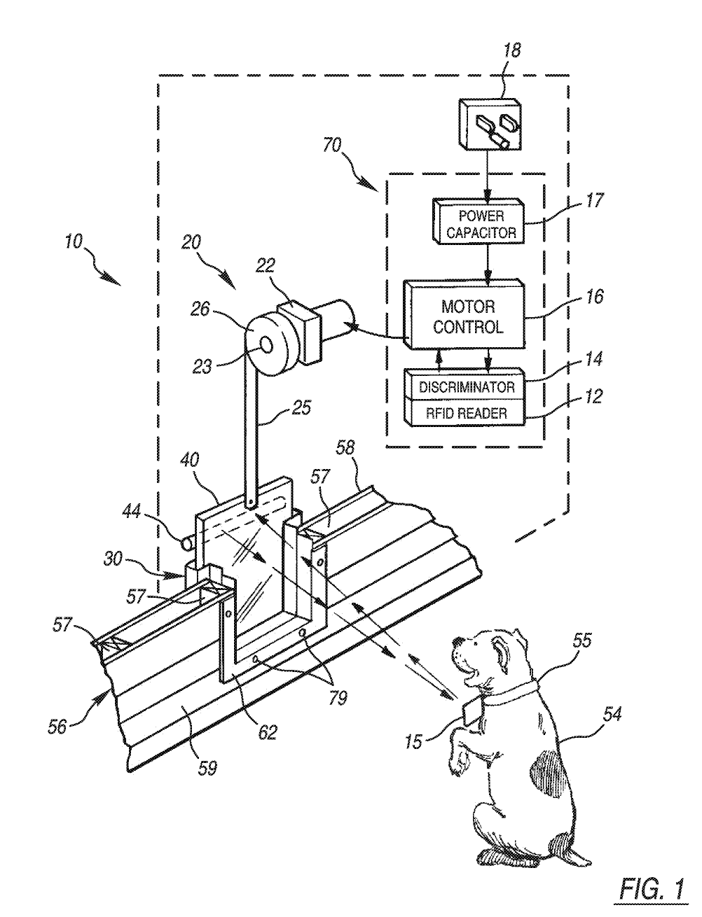

FIG. 1 provides a useful overview of the pet door device 10 of one embodiment of the present invention. The pet door device 10 includes a control assembly 70 which controls a gear motor and spring assembly 20 that comprises a gear motor 22 and a constant tension spring 25. The gear motor and spring assembly 20 may raise and lower a sliding panel 40 confined within a frame assembly 30 which is preferably mounted on the inner surface 58 of the wall 56 of the enclosure. The span of the portion of the frame assembly 30 that mounts between the studs 57 of the wall may be preferably less than the opening between the studs 57 so the pet door device 10 may be installed without very costly reworking of the framing of the wall 56. As will later be made clear, this pet door device 10 allows the height of the opening in the wall 56 to be made little more than what is required to clear the back of the largest pet expected to pass through it. The control assembly 70 may include a plug-in power supply 18 which, in the preferred embodiment, supplies low voltage power to a power capacitor 17 which aids the power supply 18 in supplying power to a motor control 16, a RFID reader module 12 and a code discriminator module 14.

The RFID reader module 12 communicates with a ferrite antenna 44 which broadcasts power which is received and absorbed by an otherwise unpowered RFID tag 15, ideally mounted on a collar 55 of the pet 54, and, in turn, causes the RFID tag 15 to radiate a coded signal of sufficient strength to be read by the ferrite antenna 44 at a distance which is preferably in the range of 10 to 18 inches or 18 to 24 inches. The received coded signal is sent by the RFID reader module 12 to the code discriminator module 14, which if the received code matches the one or more it is programmed to accept, it sends a brief signal to the motor control 16.

Upon being signaled, the motor control 16 energizes the gear motor 22, which may preferably comprise a 12 VDC gear motor with a nominal speed of 33 rpm and a 6 lbs-in running torque, causing its output shaft 23 to rotate. Fixed to its output shaft 23 is a spring pulley 26 mounting a constant tension spring 25 which is attached to the sliding panel 40 and thereby causing the sliding panel 40 to rise, i.e., the constant tension spring biases the sliding panel 40 upward, relative to the orientation of FIG. 1, toward the gear motor 22. In the embodiment of the invention disclosed in FIG. 1, for example, the constant tension spring 25 comprises a constant tension tape spring, constructed as a flat ribbon of high tensile metal such as stainless steel or the like, and which are commercially available from Vulcan Spring & Mfg. Co. of Telford, Pa., USA. In another embodiment, the constant tension spring 25 may comprise a NEG'ATOR® spring, which is commercially available from Ametek Inc. of Paoli, Pa., USA. In one embodiment, the constant tension spring 25 for use in a pet door apparatus such as that disclosed herein includes a stainless steel constant tension spring having a width of between approximately 0.75 inches and approximately 1.5 inches, and preferably approximately 1 inch, a thickness of between approximately 0.012 inches and approximately 0.022 inches, and preferably approximately 0.014 inches, and an inside coil diameter of between approximately 3 inches and approximately 5 inches, and preferably approximately 4 inches. So configured, the constant tension spring 25 generates a force of between approximately 14 oz and approximately 2.5 pounds, and preferably approximately 1.5 pounds of pull.

The manner in which this is accomplished and how the sliding panel 40 descends will be described below. The RFID reader module 12 and code discriminator module 14 may be purchased as an off the shelf or slightly modified stock item. For example, in one embodiment, the RFID reader module 12 may comprise a 12 volt or 5 volt RFID chip and the code discriminator module 14, which is commercially available as a combined package from Texas Instrument Co., as part #TMS3705. They may be integrated with each other and the motor control 16, or not as may be convenient to any particular embodiment of this invention. While the RFID reader module 12 and code discriminator module 14 may be conventionally available components of the system, the RFID tag 15, at least in one embodiment, comprises a smart fob device having a microprocessor-based RFID transponder with a programmable microchip. So configured, the tag 15 is adapted to be programmed with a code broadcasted from the antenna 44. For example, one form of the tag 15 may be field programmed. To program the microchip of the tag 15 to the code broadcasted by the antenna 44, a user holds the tag 15 in close proximity to the antenna while depressing a switch in the circuitry of the micro-processor for a fixed amount of time, e.g., 5 seconds. Upon the expiration of the fixed time period, the tag 15 may be read and if the correct code is detected, the micro-processor may cause an audible or a visual signal to the user signaling that the programming code has been successfully completed. This advantageously provides a consumer with the option to purchase and program any given number of programmable tags 15 to work with his/her installed system. Moreover, it advantageously allows a consumer to reprogram any given tag 15 to operate with a different pet door system. For example, a consumer whose neighbor also has a pet door constructed in accordance with the present disclosure, may temporarily choose to provide the neighbor's pet access for a weekend. In such a situation, the consumer may program the neighbor's pet's tag 15 to access his/her system for the weekend and, after the weekend, the neighbor may reprogram the tag to operate with his/her pet door. Accordingly, the programmable tag 15 provides for a versatile device adapted to be programmed with a code that is unique to the pet door assembly. The micro-processor may work in conjunction with switches to change the code when desired and with other switches to change the allowable time for opening and closing.

As is widely practiced in this art, the outside of the opening in the wall 56 of the enclosure may be trimmed with an outside wall trim 62 which is fastened to the outside surface 59 of the wall 56 with multiple screws 79.

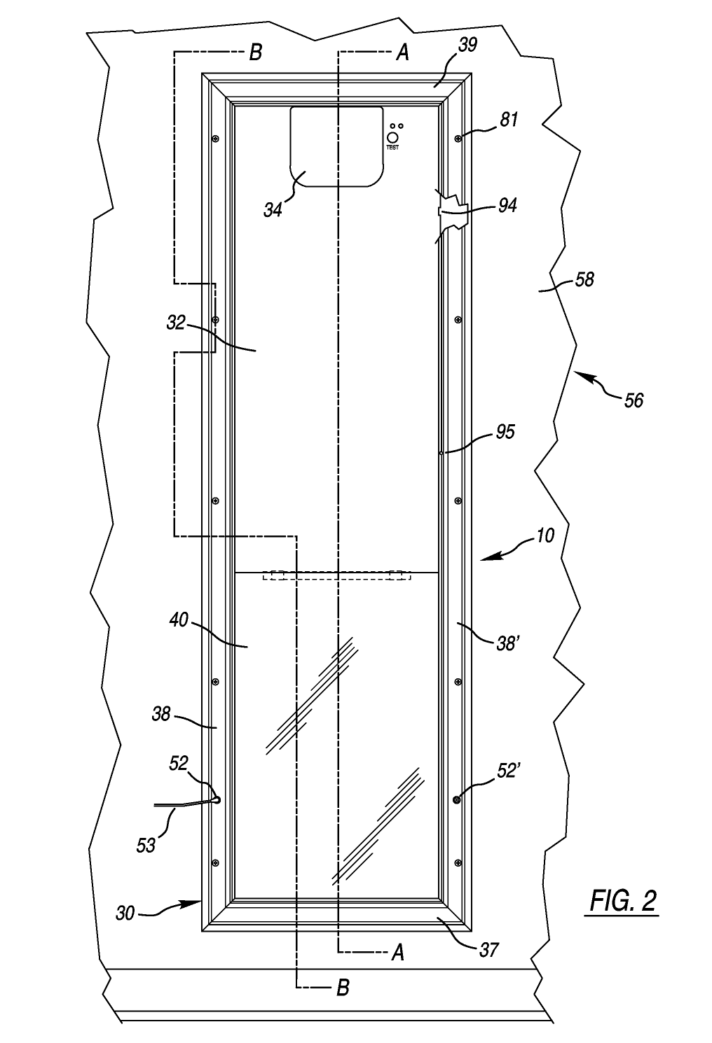

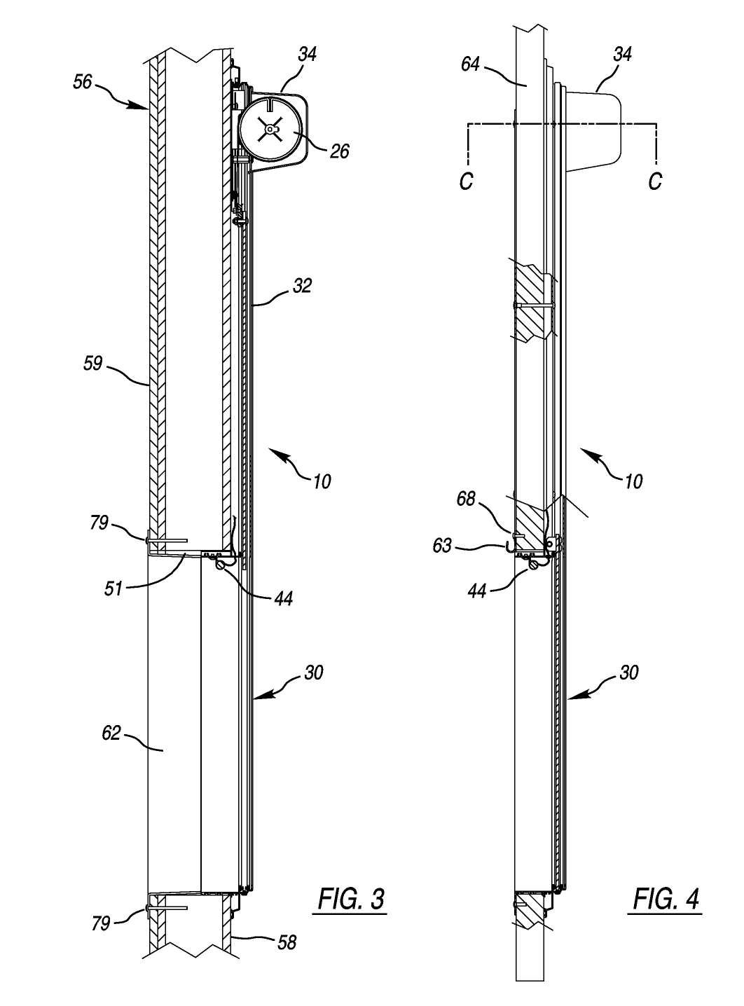

FIG. 2 illustrates the pet door device 10 mounted on the inner surface 58 of the wall 56 of the enclosure. The sliding panel 40 is shown in the closed position. Above it is a cover panel 32 which may enclose and shield the control assembly 70 and the gear motor and spring assembly 20 from view. Near a top of the cover panel 32 may be a cover cap 34 which may be employed to conceal a portion of the gear motor and spring assembly 20 and when removed, may provide access to a fastening means for retaining the cover panel 32 in place. The frame assembly 30 includes a bottom frame member 37, two side frame members 38 and 38′ and a top frame member 39. Preferably, only the two side frame members 38 and 38′, may be fastened to the inner surface 58 of the wall 56 with multiple screws 81. The cover panel 32 may have a notch 94 positioned along its side edge such that when in the lowered position, the notch 94 may coincide with the location of a tapped hole 95 in one of the side frame members 38 or 38′. Located in either the bottom frame member 37 or the side frame members 38 and 38′ may be one or more power jacks 52 and 52′, one of which may receive the power plug and cord 53 coming from the power supply 18. The function of the cover cap 34 becomes more clear when viewing FIG. 3 wherein the protrusion of the spring pulley 26 beyond the plane of the cover panel 32 is demonstrated, as does the function of the outside wall trim 62 which closes off the outward portion of the exposed sides of the opening 51 in the enclosure. How the frame assembly 30 may close off the balance of the exposed sides of the opening 51 in the enclosure will be made clear by subsequent Figures. The pet door device 10 may also be mounted in a door 64 of the enclosure and this is illustrated in FIG. 4. As is customary in this art, the top of the opening in the door 64 may have a rain gutter shape 63 extending from side to side, which may be fastened to the door 64 with multiple screws 68.

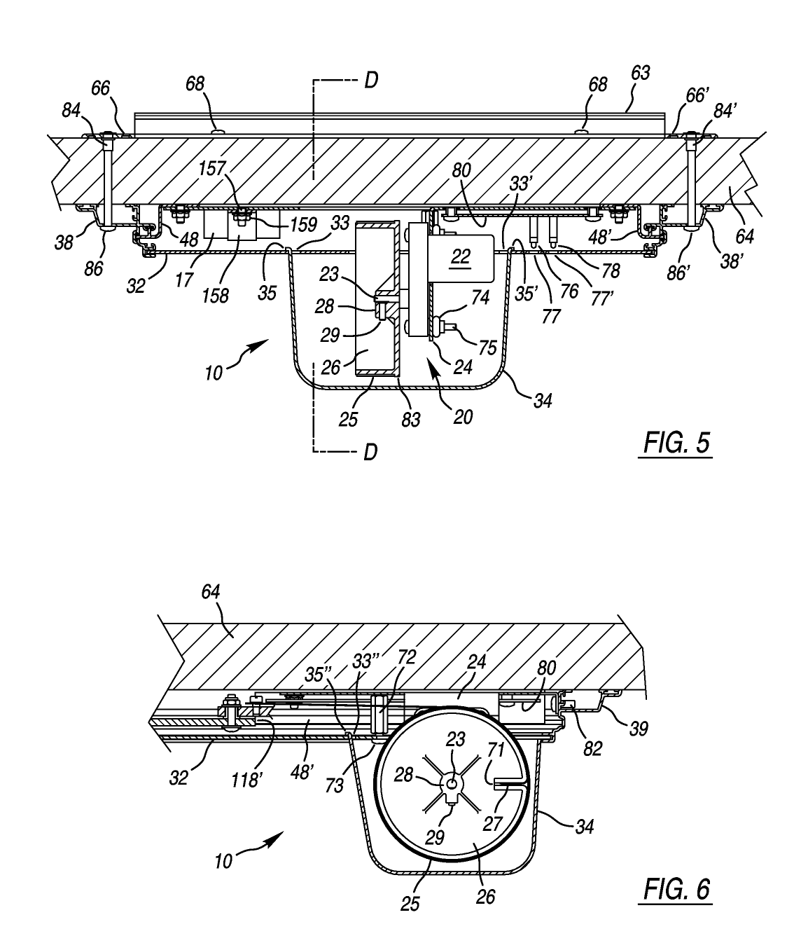

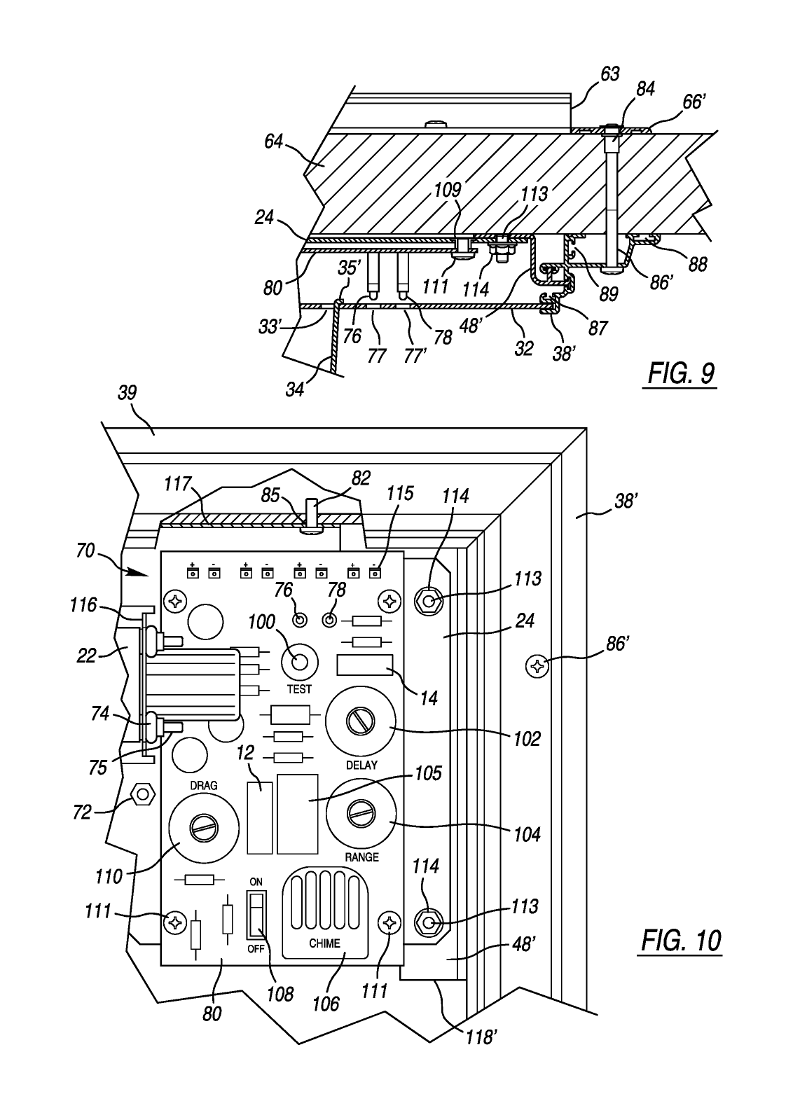

In FIGS. 5 and 6, and others, the door 64 is cross-sectioned as if it were a solid door. Such may be the case for some doors, but the majority of doors are so-called, hollow-core. Because of this, it is a common practice in this industry to fasten the side frame members 38 or 38′ of the pet door device 10 to the door 64 with multiple long screws 86 and 86′ that may thread into multiple captive nuts 84 and 84′ that are respectively staked into vertical outside door trim 66 and 66′. These Figures also better define the gear motor and spring assembly 20. The spring pulley 26 may be fastened to the output shaft 23 of the gear motor 22 by a set screw 29 passing through the hub 28 of the spring pulley 26. The gear motor 22 may be mounted to a bracket 24 with one or more screws 75 that are threaded into a resilient isolated mount 74 that is attached to the bracket 24. The bracket 24 may also support one or more printed circuit boards 80 and one or more power capacitors 17 of the control assembly 70. The bracket 24, better shown in FIG. 9, may be fastened to extrusions 48 and 48′ which may be staked or bonded to side frame members 38 and 38′ respectively. However, there are many ways to attach the cover cap 34 to the cover panel 32, known to those of ordinary skill in the art. A preferred method may be to employ fingers 35, 35′ and 35″ that extend through the cover panel 32 and hook a short distance behind it. They pass through apertures 33, 33′ and 33″ respectively which may be wide enough to permit the sides of the cover cap 34 to be depressed far enough to permit the hook portion of the various fingers to move from behind the surface of cover panel 32 and escape through their corresponding apertures. As best shown in FIG. 6, the cover panel 32 may be fastened by a cover fastener 73 which may be threaded into a stand-off 72 which may be staked or fastened to the bracket 24. The printed circuit board 80 may contain a power-on indicator light 76 and a code detected indicator light 78 which may be visible through holes 77 and 77′ respectively. As best shown in FIG. 6, the constant tension spring 25 may have a generally radial oriented inner tang 27 that may be retained by a generally radial slot 71 in the spring pulley 26. The residual curvature of the tang 27 can cause it to firmly engage the inner surfaces of the slot 71 to maintain the connection between the tang 27 and the pulley 26. As best shown in FIG. 5, there may be a short radial flange 83 at the rim of spring pulley 26 that may serve to limit the axial movement of the constant tension spring 25. Alternatively, the residual curvature of the tang 27 engaging the slot 71 may retain the axial alignment of the constant tension spring 25. In still a further alternative embodiment, the constant tension spring 25 may not be attached to the pulley 26 via a tang 27 at all, but rather with a fastener such as a screw. For example, the constant tension spring 25 may include a countersunk hole in the innermost coil for receiving a flat head screw. The countersunk hole in the constant tension spring 25 would allow for the screw head to lie flat with the constant tension spring 25, thereby allowing the next coil to lie flat above it. In such case, the rim of the pulley 26 would have a corresponding, counter sunk, tapped hole. The bracket 24 may also serve to retain the top frame member 39 in engagement with the side frame members 38 or 38′ by the use of one or more screws 82 that pass through the bracket 24 and thread into the top frame member 39.

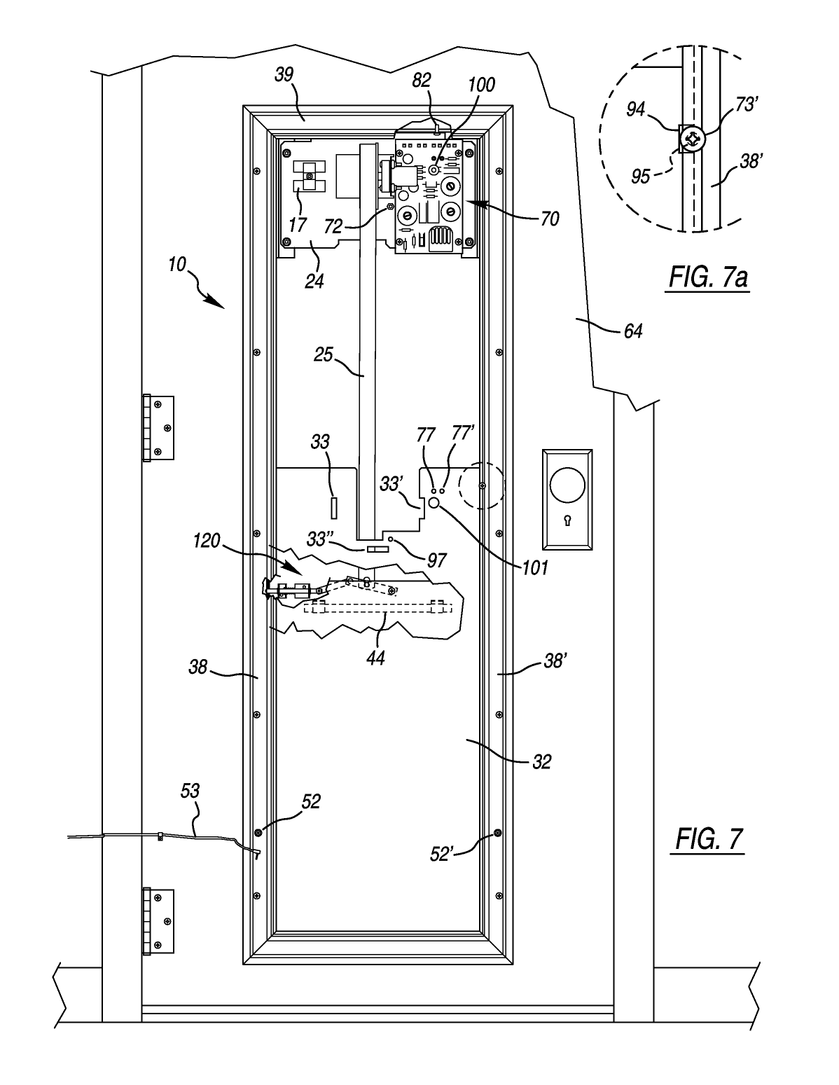

FIG. 7 illustrates the pet door device 10 installed in a door 64 and, in this case, in an extended unused or “vacation” mode. The cover panel 32 is in the fully down position exposing the control assembly 70 and the constant tension spring 25. The latch linkage 120, which will be fully described later, is illustrated engaged into the side frame member 38. The cover fastener 73 which normally passes through hole 97 has been removed from the stand-off 72 in order to permit the cover panel 32 to descend and has been rethreaded into a tapped hole 95 in side frame member 38′. This is best shown in FIG. 7a where the cover fastener 73 is now designated 73′ and the notch 94 in cover panel 32 may be engaged by the cover screw 73′. Thus restrained, the cover panel 32 acts as a supplemental barrier to the protection provided by the latched, sliding panel 40. The power plug and cord 53 is shown unplugged from the power jack 52 thus disconnecting power from the control assembly 70. Best illustrated in FIG. 7 are the suggested locations for apertures 33, 33′ and 33″ as well as the holes 77 and 77′ and the aperture 101 through which a user can press a test switch 100 when the cover panel 32 is in its normal position. As best shown in FIG. 5, a power capacitor 17 is shown that may be mounted to a captive stud 157 that may be staked to the bracket 24. A clip 158 may grip the power capacitor 17 and in turn may be fastened to the captive stud 157 by a nut 159.

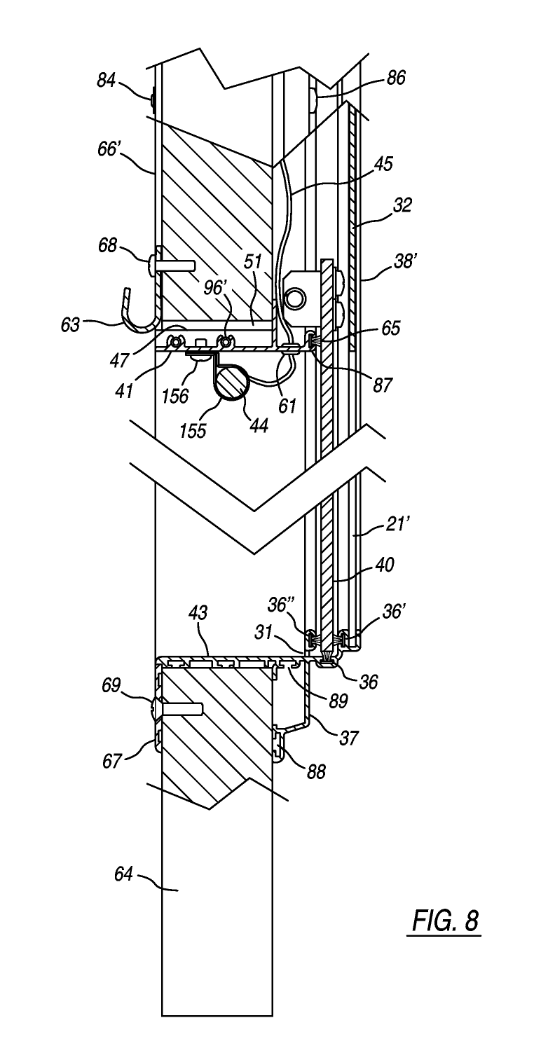

There may be a frame cross member 41 that is fastened to the side frame members 38 and 38′ by use of multiple screws 96 (not shown) and 96′. This is best illustrated in FIG. 8. The ferrite antenna 44 may be mounted a spaced distance from cross member 41 by many optional means, such as the illustrated, one or more clamps 155 secured to the cross member 41 by one or more screws 156. The lead cable 45 of the ferrite antenna 44 may pass through a grommeted hole 61 in the cross member 41 on its way to connection to the control assembly 70. In this figure the sliding panel 40 is in the closed position and the cover panel 32 is in its normal, up position which exposes a portion of the channels 21 (not shown) and 21′ that are part of the side frame members 38 and 38′ respectively and by which the cover panel 32 may be guided and restrained. Identified in the bottom frame member 37, but present as well in the others frame members 38, 38′ and 39 are at least one horizontal T slot 88 and preferably at least one vertical T slot 89 that may receive and retain mating corner keys which are illustrated elsewhere.

The sliding panel may be guided and sealed against wind and water by one or more weatherseals on at least one surface such as fibrous weatherseals, elastomeric weatherseals, or some other type of seals. In the disclosed embodiment, the bottom frame member 37 includes a groove for receiving the sliding panel 40. The groove has a generally U-shaped cross-section and contains three T-slots for retaining seals 36, 36′, 36″, as depicted in FIG. 8. Specifically, seal 36 is an edge weatherseal 36, seal 36′ is an inside surface weatherseal 36′, and seal 36″ is an outside surface weatherseal 36″. The edge weatherseal 36 therefore seals against a bottom edge of the sliding panel 40. The inside surface weatherseal 36′ seals against an inside surface of the sliding panel 40. The outside surface weatherseal 36″ seals against an outside surface of the sliding panel 40. Each of the weatherseals 36, 36′, and 36″ are retained in respective weather seal T slots 87, having a preferred shape as depicted in FIGS. 8 and 9. Other embodiments, however, may have different cross-sections adapted to retain the weatherseals to prevent pets from being able to chew or scratch the weatherseals, or even bite the weatherseals and pull them away from the frame. The weatherseals 36, 36′ and 36″ may be used on the bottom frame member 37 and on the portion of the side frame members 38 and 38′ that is traveled by the sliding panel 40.

The bottom outside door trim 67 may be secured to the door 64 by screws 69 as shown, or optionally, long screws 86 and captive nuts 84. As are illustrated in FIG. 5, there may be one or more drain slots 31 in the bottom frame member 37 to allow any water that accumulates in it to drain to the outside. The cross member 41 may also have a weatherseal T slot 87 adjacent to the outer surface of the sliding panel 40 into which weatherseals 65 may be retained and would serve to seal the outside surface of the sliding panel 40 near the top of the opening 51 in the door 64 or the wall 56 of the enclosure. As illustrated in FIG. 8, the bottom frame member 37 and the side frame members 38 (not shown) and 38′ have a portion 43 of their extruded shapes that enter and line the opening 51 in the door 64 or the wall 56. By cutting away that part of the portion 43 of the side frame members 38 and 38′ so that the upper ends 47 of the remaining portions 43 is just below the upper edge of the opening 51 the balance of the side frame members 38 and 38′ are completely on the inside of the door 64 or the wall 56 and need be no thicker than is required to contain the control assembly 70, the latch linkage 120 and the cover panel 32 that conceals them. This accomplishes minimizing the opening 51 that must be cut in the enclosure and minimizing the intrusion the pet door device 10 makes into the enclosure.

FIGS. 9 and 10 illustrate a preferred, but only one of the many optional ways, the gear motor 22, the control assembly 70, the bracket 24 and elements of the frame assembly 30 may be tied together in a manner that promotes easy and secure assembly and simply, accessible field serviceability. Since the two sectional views of FIGS. 9 and 10 show the side of the pet door device 10 with elements having a prime indicator on some of their numerals, it should be understood that the corresponding other side would have those elements without the prime indicator attached to their numerals. The extrusions 48 and 48′ may be slid into and then staked or bonded in place in one or more of the weatherseal T slots 87 of the side frame members 38 and 38′ respectively at or near their upper extremities. The location of and the length of the extrusions 48 and 48′ may be selected so that their bottom ends 118 and 118′ respectively may serve as positive end stops for the upward travel of the sliding panel 40 and thus protect the elements of the control assembly 70. Staked into each of the extrusions 48 and 48′ are one or more captive threaded studs 113 which with mating nuts 114 are used to fasten the bracket 24 which spans and thus rigidly positions and fastens together the side frame members 38 and 38′. The upper most extent of the bracket 24 has a flange 117 which may have one or more holes 85 through which one or more screws 82 may serve to fasten the top frame member 39 in place. The bracket 24 may have a tall vertical flange 116 that may be used to mount the gear motor 22 using two or more screws 75 that are threaded into two or more resilient isolated mount 74 that are attached to the bracket 24. The one or multiple printed circuit boards 80 may be mounted to the bracket 24 by two or more threaded captive stand-offs 109 that are staked into the bracket 24 and by screws 111 threaded into them, as illustrated, or by any of the many types of plastic snap-in hardware made for that purpose. In addition to the previously described components, also present on one of the printed circuit boards 80, may be a RFID reader module 12, a code discriminator module 14, a variable resistor 110, a variable timing capacitor 102, a variable tuning capacitor 104, a motor control relay 105, a sounding device 106, a sounding device control switch 108 and multiple quick connect terminations 115. The latter may be in the form of push-on terminals as illustrated or a terminal strip or any of the many options that permit rapid connection of wires from other sources to the printed circuit boards 80.

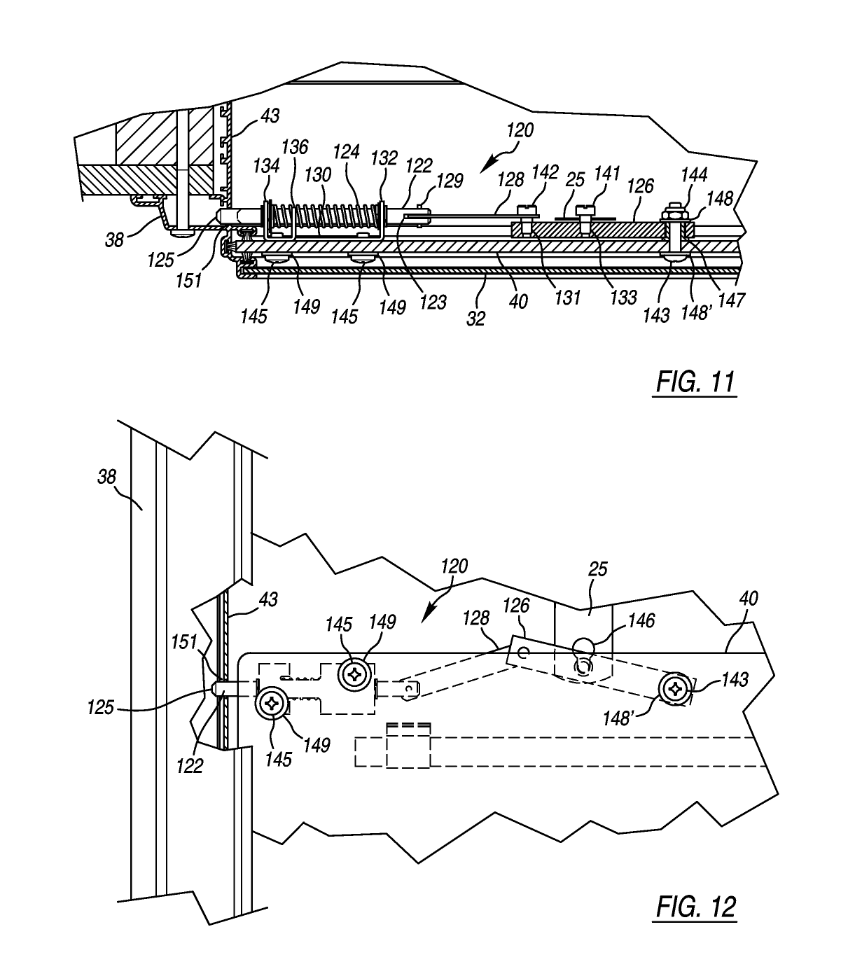

The latch linkage 120 is illustrated in FIGS. 11 through 14, and it can engage either of the side frame members 38 and 38′ to lock the sliding panel 40 in the closed position. For purposes of illustration, side frame member 38 is used. Such devices have and are being used in the pet door industry, but the latch linkage 120 of this disclosure offers advantages over the prior art. A latch bracket 130 may be fastened to the sliding panel 40 with pairs of screws 145 and washers 149. The latter may rest and distribute the load on the sliding panel 40. Nuts could be employed to mate with the screws 145, but the preferred method would be to use tapped holes in the latch bracket 130. Its preferred location may be the upper portion of sliding panel 40 and as close to the side frame member 38 as is practical. The latch may have a plunger 122 which may pass through the inner flange 132, the intermediate flange 136 and the outer flange 134 of the latch bracket 130 and terminate in a preferably tapered end 125 which, when the sliding panel 40 is in the fully closed mode, may pass through and engage an aperture 151 in the side frame member 38. The opposite end of the plunger 122 may have a slot 123 and a cross hole perpendicular thereto, through which a captive pin 129 pivotably secures a link 128 to the plunger 122. Displaced inward from the latch bracket 130 is a lever 126 which is pivotably mounted to the sliding panel 40, preferably with a flanged bushing 147 inside its pivot hole. The flange may serve to space the lever 126 slightly away from the surface of the sliding panel 40. Preferably a shoulder screw 143 would pass through the sliding panel 40 and the flanged bushing 147 with a washer 148 beneath a preferably self locking nut 144 at the far end. A second washer 148′ could be under the head of the shoulder screw 143 to distribute the load on the sliding panel 40. The location of the shoulder screw 143 may be approximately as high on the sliding panel 40 as is the axis of the plunger 122. The lever 126 may have a tapped hole 131 at its opposite end into which may be threaded a shoulder screw 142 from the side of the lever 126 opposite the sliding panel 40. Pivotally secured on the body of the shoulder screw 142 is the end of the link 128 opposite the end that is pinned to the plunger 122. Between shoulder screws 143 and 142, a third shoulder screw 141 may be threaded into a tapped hole 133 in the lever 126 from the same side as shoulder screw 142. The constant tension spring 25 may be hooked onto the shoulder screw 141 by use of an aperture 146 near its lower end which in the preferred embodiment may be in the shape of a key hole slot with its enlarged portion above the lower portion. The preferred location of the constant tension spring 25 would be approximately in line with the center of gravity of the assemblage of the sliding panel 40 and the latch linkage 120. An unlikely but anticipated variation of this invention would be the abandonment of the latch linkage 120. In such a variation, the constant tension spring 25 would be attached directly to the sliding panel 40 near its center with suitable fasteners and washers.

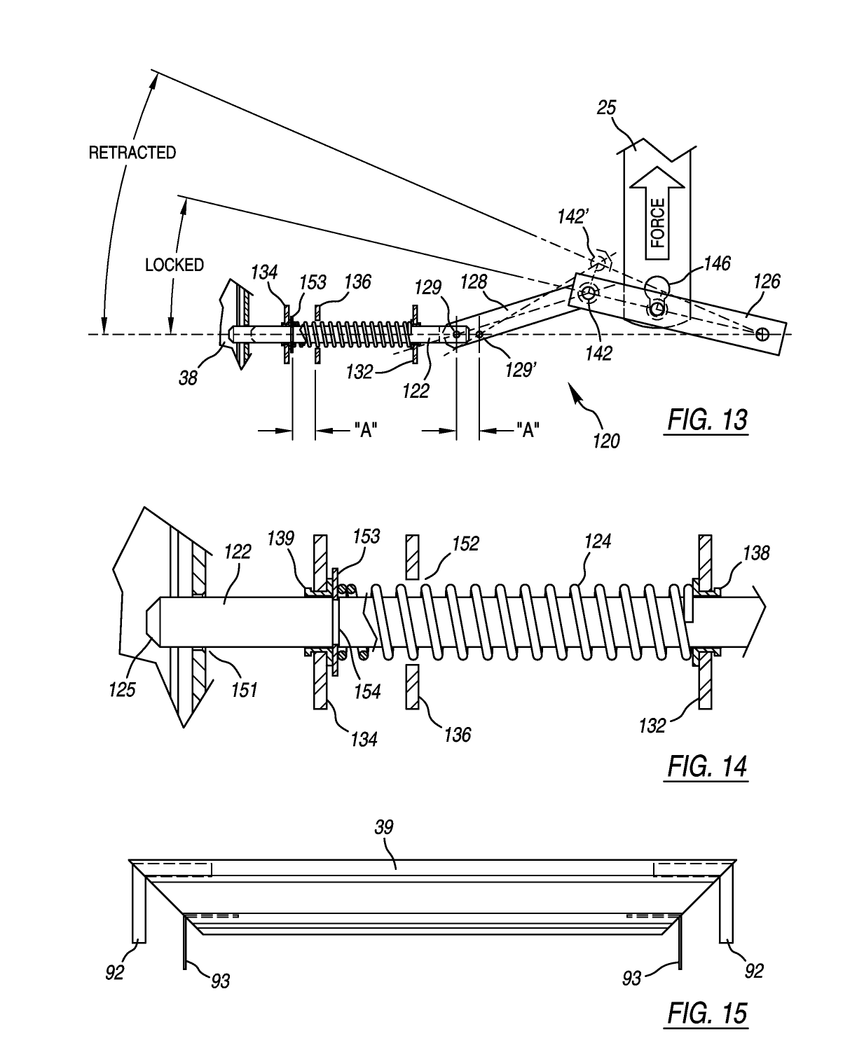

FIG. 13 illustrates the function of the latch linkage 120 and FIG. 14 illustrates a preferred embodiment that provides reduced friction and improved service life. The desired stroke length for the plunger 122 has been designated as “A” which approximates the distance required to fully withdraw the tapered end 125 from the side frame member 38 and maintain a working clearance from it so there is no possible drag on it as the sliding panel 40 moves upward. In this preferred embodiment flanged bushings 138 and 139, preferably nylon such as commercially available under the trade name of “Nyliner”, may be snapped into holes in inner flange 132 and outer flange 134 respectively of the latch bracket 130 with their larger flanges facing each other. The plunger 122 may have a snap ring groove 154 into which a snap ring 153 may be engaged. The location of the snap ring groove 154 may be such that when the face of the snap ring 153 is against the large flange of flange bushing 139, the tapered end 125 of plunger 122 has the desired penetration into the side frame member 38. Bearing against the opposite face of the snap ring 153 and the large flange of flanged bushing 138 is a compression spring 124 which is concentric with the plunger 122. The intermediate flange 136 of the latch bracket 130 has an aperture 152 wide enough to clear the outside of the compression spring 124, but not the outside of the snap ring 153. The location of the intermediate flange 136 relative to the outer flange 134 may be such that the face of snap ring 153 that contacts the compression spring 124 also contacts the face of the intermediate flange 136 when the plunger 122 is withdrawn a distance equal to “A”. Thus, the stroke of plunger 122 is limited in both directions. A washer could be employed between the snap ring 153 and the compression spring 124 if it were desired to have a larger aperture 152 in the intermediate flange 136.

Referring now to FIG. 13, in the preferred embodiment, the pull of the constant tension spring 25 must always be less than the weight of the sliding panel 40 and anything mounted on it. The constant tension spring 25 functions to lessen the required torque of the gear motor 22 and the power required for it as well as to provide resistance to, and thus slow, the decent of the sliding panel when the power is removed from the gear motor 22. The resistance of the unpowered gear motor 22 to being back-wound must be less than the torque generated by the suspended weight on the constant tension spring 25 that exceeds the frictional resistance of the weatherseals 36, 36′, 36″ and 65. If the back-winding resistance of the gear motor 22 exceeds this torque, the sliding panel 40 will not descend. However, the control assembly 70 of an alternative embodiment may be configured to provide a small amount of voltage to the gear motor 22, insufficient to make it rotate with no load, but sufficient to make it rotate in the downward direction when the net weight of the panel 40 and the latch linkage 120 is being suspended by the constant tension spring 25.

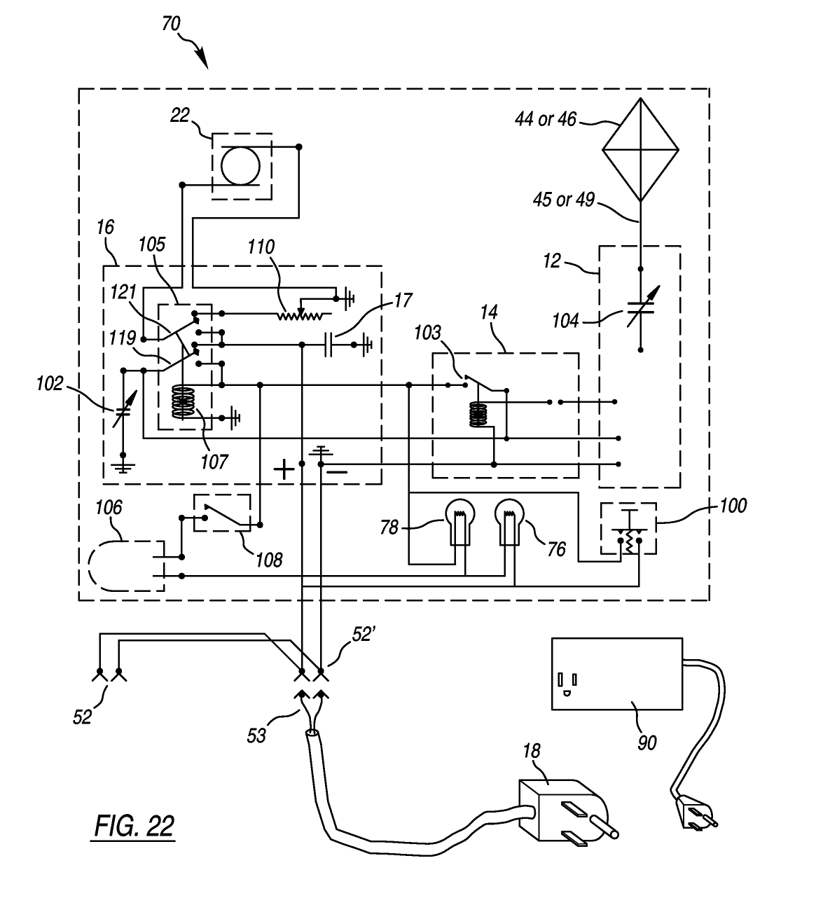

To insure proper latching when the sliding panel 40 is resting on the bottom frame member 37 and when there are no other forces acting upon the latch linkage other than the force of the constant tension spring 25 acting upon lever 126, the force of the compression spring 124 when the plunger is fully extended must exceed the frictional resistance of the flanged bushings 138 and 139 and the axial force created on pin 129. A typical operating cycle of the preferred embodiment may begin with the pet door device 10 in the latched mode and power being applied to the gear motor 22. The starting torque of the gear motor 22 passes into the spring pulley 26 adding to the intrinsic tension of the constant tension spring 25 to overpower the force of the compression spring 124 causing lever 126 to rise with shoulder screw 142 moving to the location of 142′ as the link 128 draws plunger 122 inward and pin 129 is moved to the location of 129′, a displacement equal to “A”. The lever 126 is now immobilized and further rotation of the spring pulley 26 causes the sliding panel 40 to rise to its upper limit. In one embodiment, there may be provided a magnet at the top of the sliding panel 40 that actuates a reed switch carried by the printed circuit board 80 to indicate to the control assembly 70 that the panel 40 has reached its fully open position, and power may be cut off from the gear motor 22, for example. After dwelling in the fully open position for a desired interval. A reduced amount of voltage may be applied to the gear motor 22 in the downward polarity. Because the combined weight of the sliding panel 40 and all things mounted upon it, exceeds the upward force in the constant tension spring 25, the resistance of the weatherseal 36, 36′, 36″ and 65 and the back winding resistance of the gear motor 22, when this voltage is applied, the sliding panel 40 begins its slow decent. In the illustrated embodiment, when the excess weight causes the armature of gear motor 22 to rotate, the dynamic braking which may be created by a variable resistor 110 across its leads may add retarding torque to the gear motor 22, further slowing the descent of the sliding panel 40. The variable resistor 110 is illustrated in FIGS. 10 and 22. The combined resistive force in constant tension spring 25 continues to overpower the compression spring 124 and the plunger 122 remains in the fully retracted position while the sliding panel 40 descends. Upon reaching the bottom of its travel, the sliding panel 40 may rest upon the bottom frame member 37 and the added forces cease, leaving only the intrinsic force of the constant tension spring 25 which may then be overcome by the compression spring 124 and the tapered end 125 of the plunger 122 now may penetrate the aperture 151 in the side frame member 38, locking the sliding panel 40 in the closed position. In this preferred embodiment, making resistor 110 variable allows the user to compensate for weather conditions and/or changes in the frictional resistance of the weatherseal 36, 36′, 36″ and 65 that might change the decent rate of the sliding panel 40. In one embodiment, there may be a micro-switch mounted on the cross-member 41 sensing the position of the link 28 and indicating to a micro-processor that the panel 40 is closed and the plunger 22 is latched, for example.

Accordingly, based on the foregoing, in alternative embodiments, the frictional resistance of the gear motor 22 is such that it will not turn due to the torque resulting from the weight of the panel 40 that exceeds the pull of the constant tension spring 25. The panel 40 is made to lower by applying an opposite polarity voltage to the gear motor 22 below what would cause an unloaded gear motor 22 to turn, but enough to make it turn when subjected to the torque of the weight of the panel 40 that is in excess of the pull of the constant tension spring 25. When the panel 40 bottoms out, this load disappears and the gear motor 22, even if still subjected to the reduced voltage, stops turning. As mentioned above, a magnet actuated reed switch may detect when the panel 40 has reached its full open position, The power to the gear motor 22 may then be cut-off. The panel 40 will dwell in the full open position until the programmed “up” time has timed out whereupon the timed “down” cycle begins. It also is in excess of the transit time required. When the panel 40 bottoms out, the still powered gear motor 22 stops turning and the plunger 122 engages the frame. The micro switch that senses the plunger 122 has extended into the latched condition, confirming both that the panel 40 is closed and the plunger 122 latched. Alarm conditions may be created when the “up” period times out before the reed switch is actuated and/or when the “down” period times out before the micro switch is actuated. If the micro switch is released without the unit being in a run cycle, this may indicate that a forced entry is in progress, thereby activating and an urgent alarm signal, for example.

FIG. 15 shows the top frame member 39 removed from the balance of the frame assembly 30. It is almost universal practice in this and similar industries to hold mitered corners of frames together with corner keys that are either bonded or staked into receptor slots in the frame members. Although one corner key might suffice, in this preferred embodiment two are illustrated, a horizontal key 92 and a vertical key 93, in each corner of the frame assembly 30. For clarity, they were not illustrated in the other Figures. They engage corresponding horizontal T slots 88 and vertical T slots 89 respectively in each of the frame members which are best viewed in FIGS. 8 and 9. The keys 92 and 93 in the bottom two corners of the frame assembly 30 are permanently staked or bonded to both adjacent frame members. In the case of the upper corners of the frame assembly 30, the keys 92 and 93 are permanently staked or bonded to both ends of the top frame member 39. The one or more holes 85 in flange 117 of bracket 24 through which one or more screws 82 fasten the top frame member 39 in place may preferably be made large enough so that any deviation in their location does not inhibit the exposed ends of keys 92 and 93 alignment with and free entry into corresponding T slots 88 and 89 in both side frame members 38 and 38′.

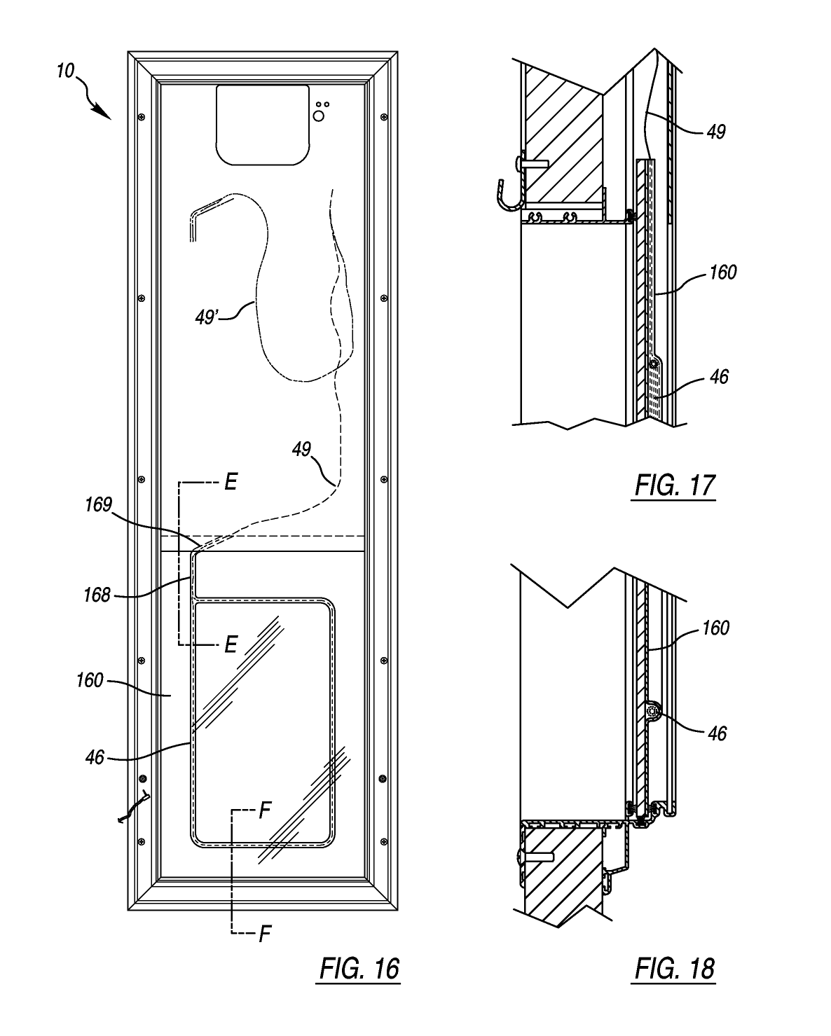

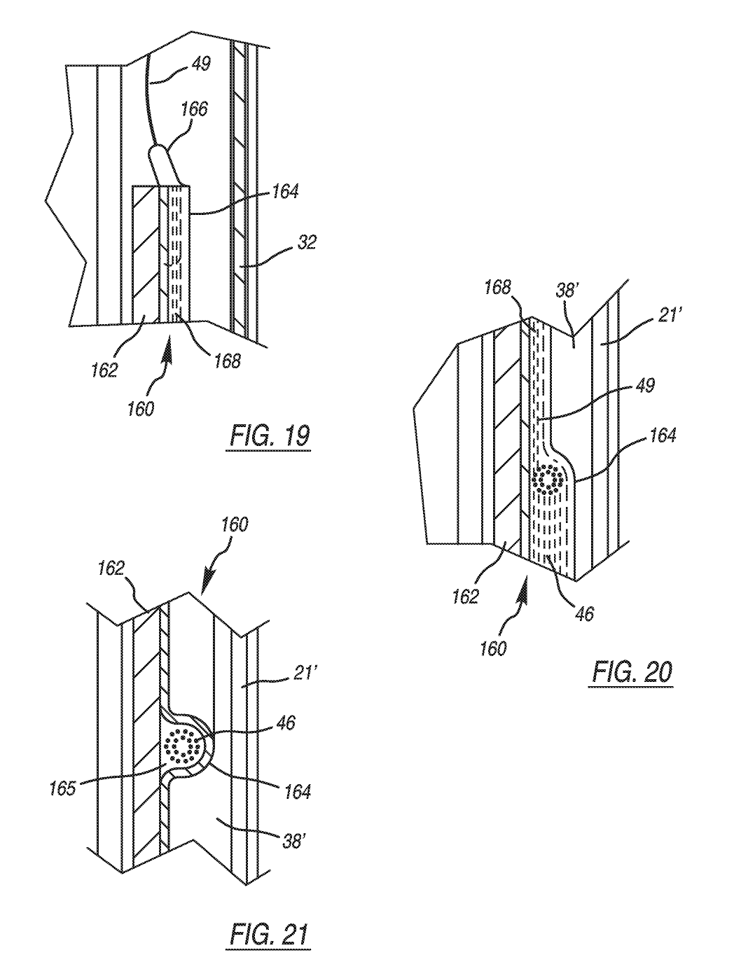

An alternative to the ferrite antenna 44, illustrated earlier, is illustrated in FIGS. 16 through 21. Also widely used in RFID technology is a flat plane antenna 46, best shown in FIG. 16. In one embodiment, the antenna 46 may include twenty-two coils of #26GA wire configured in a generally rectangular shape, as depicted in FIG. 16, for example. In the disclosed embodiment, the rectangular configuration of the antenna 46 may have a width dimension of approximately 8 inches and a height dimension of approximately 13.7 inches. The antenna 46 may be laminated within an alternative sliding panel 160. So configured, the antenna 46 operates at a low frequency between approximately 90 KHz and approximately 200 KHz, and, at least in one embodiment, 134 KHz. Its lead cable 49 may drape downward from the control assembly 70 and preferably to a laterally displaced sealed entrance 166 in the top of the alternative sliding panel 160. The sealed entrance 166 is best showed in FIG. 19. Draped in this manner, the lead cable 49 can assume a configuration similar to that of 49′ when the alternative sliding panel 160 is in the fully open position. While there are many ways to embed and seal the flat plane antenna 46 in a sliding panel 160, the preferred method may be to employ a base panel 162, having a thickness that might be ⅝ to ⅞ of the thickness of the sliding panel 40 and a formed cap sheet 164 which might be ⅜ to ⅛ of the thickness of the sliding panel 40. The thin, formed cap sheet 164 could have a deep channel 165 formed into it that would accommodate the body of the antenna 46 in the generally rectangular path, in which they are usually configured and which may communicate with a smaller, shallower channel 168 that would accommodate its lead cable 49. The shallower channel 168 may begin coaxially with the deep channel 165 and then may have an angled portion 169 that exits the alternative sliding panel 160 causing the lead cable 49 to also assume that angle which may better induce the lead wire 49′ configuration. The antenna 46 could then be laid into the channels 165 and 168 with the lead cable 49 exiting the end of the angled portion 169 of the formed cap sheet 164. The base panel 162 could then be laid above the assemblage and solvent bonded or otherwise laminated to it. The edges of the now laminated sliding panel 160 could be trimmed to final size and polished if desired. To allow the energy to radiate from the antenna 46, both the base panel 162 and the formed cap sheet 164 should be non-metallic. Acrylic is one material, but not the only non-metallic material for this application, due to the fact that it may readily be laminated together with MEK or possibly other solvents. By having the formed cap sheet 164 on the inside of the sliding panel 160, the weatherseal 65 that seals the top of the opening 51 has a smooth, planar surface to act upon. The latch linkage 120 is above the weather seal 65 and on that side of the sliding panel 160, opposite to the formed cap sheet 164, so that it should not contact or distress the lead cable 49 as it moves upward with and drapes on the inward side of the sliding panel 160. The seal 166 at the end of the angled portion 169 of the shallower channel 168 may seal the cavity in the laminated sliding panel 160 and may serve as a stress reliever for the lead cable 49 as it exits the sliding panel 160. In accommodating the alternative flat plane antenna 46 the frame assembly 30 must be extended slightly inward into the enclosure so that the cover panel 32 has adequate clearance to permit the lead cable 49 to freely pass between it and the largest projection of the formed cap sheet 164.

The electrical schematic to the control assembly 70 is illustrated in FIG. 22. For purposes of clarity and to avoid trying to illustrate what has long been commercially available, the RFID reader module 12 and the code discriminator module 14 have been shown in block form. To make the function of the motor controller 16 more understandable, it has been shown as if a DPDT relay 105 were employed. Although it may be used, in the preferred embodiment, solid state components on one or more printed circuit boards 80 would more likely be employed with the components of the modules 12 and 14 integrated with them. The plug in power supply 18 may be a simple transformer and rectifier bridge providing current which is insufficient to cause the gear motor 22, which may be aided by the lifting power of the constant tension spring 25, to make the sliding panel 40 or 160 and anything mounted upon it to rise. When not connected to the gear motor 22, the power supply 18 should provide sufficient current to power both the modules 12 and 14.

Referring to the schematic of FIG. 22, the common of the first pole 119 of the DPDT relay 105 may be connected to a capacitor 102, which preferably may be variable, and to both the modules 12 and 14. The common of the second pole 121 of the DPDT relay 105 may be connected to one lead of the gear motor 22. Its other lead may be connected to both the slider of a variable resistor 110 and the negative input from the power supply 8. The first normally closed contact of the DPDT relay 105 may be connected to the positive input from the power supply 8, the power capacitor 17 and the second normally open contact of the DPDT relay 105. The second normally closed contact of the DPDT relay 105 may be connected to one end of a preferably variable resistor 110. The first normally open contact of the DPDT relay 105 may be connected to its coil 107, and to the output of a momentary contact closure 103 within the code discriminator module 14 that can receive the positive output from the power supply 18 when a satisfactory code is received. This contact may also be connected to one lead of a code detected indicator light 78 and a normally open, momentary test switch 100 that has its other contact connected to the positive input from the power supply 18. It should be noted that some commercially available RFID modules include the indicator lights 76 and 78. This same first normally open contact of the DPDT relay 105 may also be connected to a sounding device 106 which connection may be interrupted by a switch 108 which may be used to disable it or modulate its volume. The RFID reader module 12 may communicate with the antenna 44 or 46 by cable 45 or 49 respectively and may contain a variable capacitor 104 which may be used to tune or de-tune the effectiveness of the antenna 44 or 46 to adjust the operating range of the pet door device 10.

When the power supply 18 is plugged into an outlet within the enclosure and its cord and power plug 53 is plugged into one of the power jacks 52 or 52′, the power indicator light 76 may be illuminated, the power capacitor 17 and the variable timing capacitor 102 may be charged, the RFID module 12 may be powered, and its antenna 44 or 46 may begin radiating energy outside and inside the enclosure. When a coded signal is received from an RFID tag 15 it may be passed from the RFID reader module 12 to the code discriminator module 14. If it is the correct code, there may be a momentary contact closure 103 caused by the code discriminator module 14 accepting the coded signal. This momentary pulse of power may cause the coil 107 of the DPDT relay 105 to cause its first and second poles 119 and 121 respectively to close and the code detected indicator light 78 and the sounding device 106 to activate if the latter's switch 108 is enabled.

The closing of the first pole 119 causes the power to be cut off from both modules 12 and 14 and the preferably variable capacitor 102 to maintain the relay 105 in the closed mode until the charge in the capacitor 102 has fallen below the holding requirements of the coil 107. The value of the capacitor 102 and its resultant timing of the power to the gear motor 22 may be based on a compromise between the time required to safely allow the pet to pass through the pet door device 10 and the time the interior of the enclosure is exposed to adverse weather and the possible intrusion of undesirables. If the capacitor 102 is variable as may be preferred, the pet owner has the ability to adjust this timing according to his experience with the pet and personal preferences.

The closing of the second pole 121 may cause the gear motor 22 to start turning, powered by the combined outputs of the power supply 8 and the power capacitor 17. The latter may be sized so as to be exhausted when the sliding panel 40 or 160 approaches the upper limit of its travel. The remaining source of power, the output of the power supply 18, may be only sufficient to permit the sliding panel 40 or 160 to gently coast upward into the bottom surfaces 118 and 118′ of extrusions 48 and 48′ respectively and remain there until the poles 119 and 121 spring back to the open position. When this occurs, the sliding panel 40 or 160 may begin its controlled descent and subsequent latching in the closed position. In addition, the power supply 18 begins to recharge capacitors 17 and 102 and when this is done, its full current is available to power modules 12 and 14 so they may become capable of instigating another cycle when a properly coded RFID tag 15 comes within range. A momentary, normally open, test switch 100 may be incorporated to substitute for the momentary contact closure 103 of the code discriminator module 14 to allow the user to observe and adjust, if desired, the operation of the sliding panel 40 or 160.

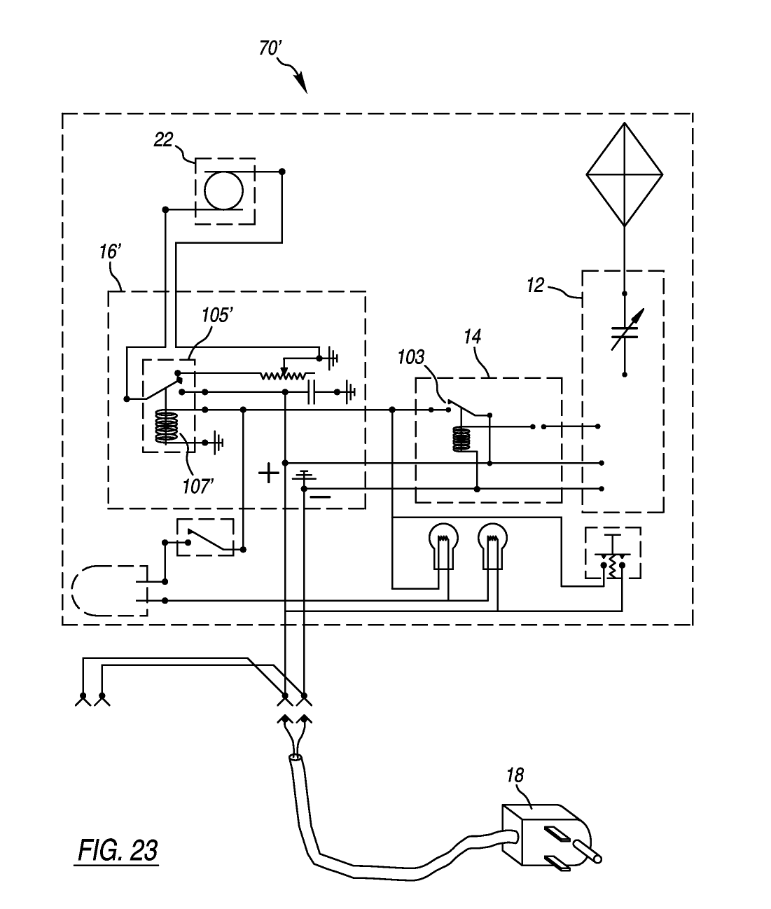

With the personal freedom provided by this pet door device 10 comes the responsibility to and consideration of the user's neighbors. Depending upon conditions near the enclosure and the nature of the pet or pets involved, it might be very desirable to restrict the pets' ability to go outside in the night hours, when young school children are expected to be passing, when church services are being held, etc. A programmable timer 90, that may have either a 24 hour or weekly period, could be built into the pet door device 10, but in its preferred embodiment it may be one of many low cost, UL approved, commercially available, programmable timers 90 into which the power supply 18 may be plugged should this option be desired. A manner of keeping the sliding panel 40 or 160 fully opened until the pet is safely away from being injured from the closing of the sliding panel 40 or 160 would be to keep the gear motor 22 powered until the pet passed through the opening and went past the limit of the range of the RFID reader module 12 on the opposite side. FIG. 23 illustrates such an alternative control assembly 70′ wherein the relay 105′ may now be a SPDT, or the solid state equivalent. The momentary closure 103 of the code discriminator module 14 will remain closed as long as the RFID reader module 12 is sending the correct coded response from the RFID tag 15. This would eliminate the need for the variable capacitor 102 to keep the coil 107′ energized. The two modules 12 and 14 may be continuously powered instead of being unpowered in response to a momentary contact closure 103 as could be the case of the preferred control assembly 70. This alternative to the assembly 70 creates several issues. The power supply 18 would have to be large enough to power the two RFID modules 12 and 14 as well as maintain the gear motor 22 with sufficient torque to resist back winding. In addition, there is a considerable distance between the location of the RFID tag 15 and a large dog's tail relative to the desirably restricted operating range of the pet door device 10. When slowly passing through its opening, such a dog's midsection could be in the opening of the pet door device 10 when its RFID tag 15 is exiting the range limit of the antenna 44 or 46 and the dog's tail could be pinched and trapped by the slowly lowering sliding panel 40 or 160. If a pet lingered within the opening of the preferred embodiment of the pet door device 10 using the preferred control assembly 70 it still would be possible for its tail to be pinched and trapped by the bottom of the sliding panel 40 or 160. That is why the constant tension spring 25 is so important. While others have employed a guided counter weight and multiple pulleys and rope and attachments, this pet door device 10 employs the constant tension spring 25 as the link between the gear motor 22 and the sliding panel 40 or 160 and the link that controls the latch linkage 120 while also performing the function of the counterweight and its related structure. A large size sliding panel 40 or 160 could weigh 3 or 4 pounds. In addition to greatly lowering the power requirements of the gear motor 22, the constant tension spring 25, in combination with the frictional resistance of the weatherseal 36, 36′, 36″ and 65, can reduce the force on the pet's tail to a few ounces, preventing any pain and allowing it to easily pull free. Since the fatigue life of the constant tension spring 25 is generally limited to about 100,000, this pet door device 10 allows a broken constant tension spring 25 to be easily unhooked from the lever 126 and slid off the spring pulley 26 and replaced with a new one by the user in a couple of minutes. This ease of user servicing of the pet door device 10 extends to the ability to replace either cover panel 32 or the sliding panel 40 or 160 without removing the entire unit or disturbing its frame, other than the easily removed top frame member 39. The cover panel 32 may also serve as a back-up security panel. The weatherseal 36, 36′, 36′ and 65, in addition to the function of protecting the interior of the enclosure from wind, rain and otherwise adverse weather, also serves to guide and quiet the sliding panel 40 or 160 in its travel. It is fully anticipated that another embodiment may abandon the use of the constant tension spring 25, replacing it with a string or cable and relying upon the windage drag of the gear motor 22, the dynamic braking of a variable resistor 110, and the frictional resistance of the weatherseal 36, 36′, 36″ and 65 individually or in combination.

As is almost universally practiced in this art, gaps to uneven surfaces and seams between elements surrounding the opening in the wall 58 or the door 64 are caulked to seal them. Additional important teachings of this invention include the nature and use of its electrical power and the integration of the flat plane antenna 46 into the sliding panel 160 without making the latter overly thick and resultantly heavy, while maintaining the ability to seal the sliding panel 160 against the outside weather. The use of a spring loaded idler pulley to control the antenna lead cable 49 was contemplated as was the preferred configuration which avoids the former's complexity, cost and wear on the antenna lead cable 49. Referring to its electrical power supply 18, a switching power supply, while vastly more efficient, is much more expensive and more importantly creates radio frequency interference that can disrupt the functioning of the RFID reader 12. Since they are rather inefficient, the simple impedance protected, transformer and diode bridge type of power supply 18 advocated would get rather large and expensive as their wattage rating increases. A larger current requirement would preclude the inconspicuous and very compact jacks 52 and 52′ and power plug and cord 53. The new concept of a power capacitor 17 makes many beneficial things possible. It can function as a battery with almost limitless discharge cycles. This allows the power supply to be sized to be merely capable of running the RFID modules 12 and 14 and the gear motor 22 being primarily powered by the power capacitor 17, which may additionally level the voltage ripple from the power supply 18 which could otherwise adversely affect the performance of the RFID modules 12 and 14. The low operating frequency of the RFID module 12 with its accompanying lower cost may make the use of such sophisticated technology more affordable in a consumer product. Such systems require a relatively large target tag and require power levels that make them unsuitable for continuous use in battery powered, portable hand held units. The fact that the low frequency circuitry is simple and inexpensive helps insure its commercial viability. A tag the size of a credit card would not be a deterrent to its being used on a pet's collar. Its short range limitation, which is a problem for commercial and industrial inventory and identification purposes, is a profound advantage for this pet door device 10 as it limits the operating range and avoids unwanted operations because the pet passed within its range with no intent of passing through the device. Other pet door devices employing RFID must resort to other technology and/or devices to disable their RFID readers in this situation.

The outside of the enclosure opening 51 in a thick wall may be trimmed and sealed by a thermoformed or injection molded plastic outside wall trim 62. The outside opening 51 in what might be a hollow core door 64 may be trimmed with outside door trim 66 and 66′ that respectively utilize captive nuts 84 and 84′ and long screws 86 and 86′ that secure the door trim 66 and 66′ and the pet door 10 to the enclosure's door 64. Both of these trim methods are widely practiced in this industry. Further, it should be apparent to one skilled in the art that a horizontal travel version of this invention could be accomplished by using its constant tension spring 25 mounted on the frame bottom 37, which in such case would now be the horizontal frame's side, to simulate the function of gravity.

While the invention has thus far been illustrated and described in detail with reference to the drawings, the same is to be considered as illustrative and not restrictive in character. It should be understood that only some of the possible embodiments have been shown and described and that all changes and modifications that come within the spirit of the invention are intended to be protected.

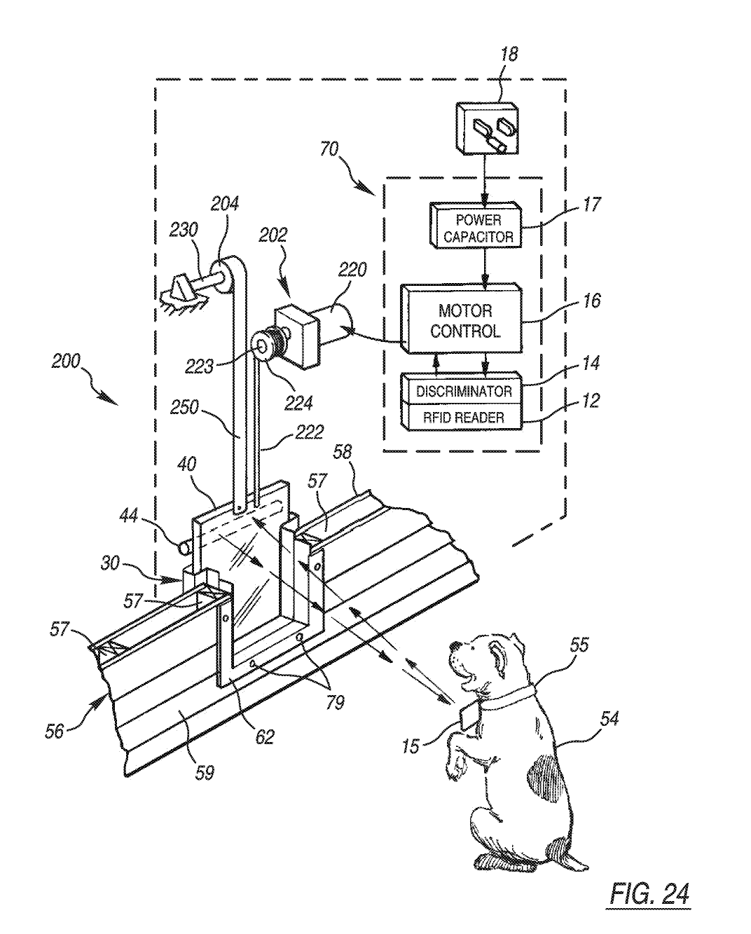

For example, FIG. 24 depicts one alternative embodiment of a spring-assisted raising and lowering mechanism, taking the form of a pet door device 200. The pet door device 200 depicted in FIG. 24 comprises substantially the same construction as the pet door 10 described above with reference to FIG. 1, and therefore, like components will be identified with like reference numerals.

Specifically, the pet door device 200 comprises a control assembly 70, a gear motor assembly 202, a sliding panel 40, and a counterweight assembly 204. The control assembly 70 controls the gear motor assembly 202 for raising and lowering the sliding panel 40, which is confined within a frame assembly 30. The frame assembly 30 is preferably mounted on the inner surface 58 of a wall 56, for example, in a manner identical to that described above with reference to FIG. 1. Additionally, the control assembly 70 is identical to the control assembly 70 described above with reference to FIG. 1, for example, and therefore a detailed description of each of its components will not be repeated. A distinction between the above-described pet door device 10 and the embodiment of the pet door device 200 depicted in FIG. 24 is apparent in the gear motor assembly 202 and the counterweight assembly 204.

Specifically, the gear motor assembly 202 disclosed in FIG. 24 comprises a gear motor 220 and a cable 222. The gear motor 220 includes an output shaft 223 attached to a reel 224 to which may be fixed the first end of the cable 222. The opposite end of the cable 222 is attached to the sliding panel 40. In one embodiment, the cable 222 may comprise a nylon strap, a steel cable, a rope, a cord, or any other type of substantially static material. In another embodiment, the cable 222 may wrap 90 degrees about a pulley located centrally at the top of the panel 40, and extending horizontally therefrom and attaching to a spring loaded plunger (not shown) which serves a function similar to the latch illustrated in FIG. 14. In another embodiment, the cable 222 may not include a cable at all, but rather, consists of a constant tension spring similar to the constant tension spring 25 described above with reference to FIG. 1, for example.

The counterweight assembly 204 comprises an axle 230 and a constant tension spring 250. The axle 230 is fixed to the frame assembly 30 of the pet door device 200 and carries the constant tension spring 250. In the disclosed embodiment, the constant tension spring 250 may be rotatably mounted and axially confined on the axle 230. Additionally, the opposite end of the spring 250 is attached to the sliding panel 40. The constant tension spring 250 therefore biases the sliding panel 40 upward, relative to the orientation of FIG. 24. In this embodiment, the constant tension spring 250 comprises a constant tension tape spring similar to the constant tension spring 25 previously described but without the inner tang 27 or the need to be fixed to its axle 230.

Accordingly, to slide the sliding panel 40 from the closed position, which is depicted in FIG. 24, to the open position, the gear motor 220 rotates the output shaft 223 to coil the cable 222 onto the reel 224. The natural bias of the constant tension spring 25 therefore assists the gear motor 220 in this process in a manner similar to the first embodiment of the pet door device 10 described above. Alternatively, in an embodiment where the cable 222 is not a cable, but rather a constant tension spring 26 mounted on a spring pulley 26, the constant tension spring 26 assists the motor 220 and the constant tension spring 250 in raising the panel 40.

After the expiration of a predetermined dwell time, i.e., after the pet has safely passed through the pet door device 200, the control assembly 70 ceases operation of the gear motor 220 and the weight of the sliding panel 40 begins to draw it toward the closed position. This causes the cable 222 to unwind from the reel 224, thereby backwinding the output shaft 223. Additionally, this causes the constant tension spring 250 to lengthen. The gear train friction generated by the backwinding of the output shaft 223 in connection with the resistive force associated with lengthening the constant tension spring 250 ensures that the sliding panel 40 descends in a controlled manner, as was described above with reference to the previous embodiment of the pet door device 10. Accordingly, it should be appreciated that a sliding door device 200 constructed in accordance with the principles of the present invention does not require the constant tension spring 250 to be directly connected to the output shaft 223 of the gear motor 220.

It should be understood that the words “motor,” “gear motor,” and “stepper motor” are meant to be interchangeable in describing this invention.

Further still, it should be appreciated that while the spring-assisted raising and lowering mechanism constructed in accordance with the present invention has thus far been described as being incorporated with a pet door device 10 and 200, the raising and lowering mechanism is not limited to applications involving pet door devices, or even doors in general. For example, the raising and lowering mechanism may be useful for raising and lowering, or simply moving aspects of point-of-purchase display components such as motion signage and the like. Furthermore, it is foreseeable that such technology may be useful in controlling the position of curtains, or media components such as projector screens, flat panel plasma or LCD televisions, chalkboards, dry-erase boards, dumb-waiter doors, or any other article. One particularly useful application of the device disclosed herein would be mounting the constant tension spring on a stepper motor as the size and cost of stepper motors rise steeply as a function of their torque and holding power ratings. Furthermore, while the pet door devices 10 and 200 described herein include the motors attached to and carried by the frames of the pet door devices 10 and 200, such a configuration is not required. For example, the motor may be attached to and carried by the wall containing the pet door device or, with respect to embodiments adapted for use with motion-based advertising-type systems, curtains, projector screens, etc., the motor may be fixed to the wall behind such article or the ceiling above such article. Thus, the present invention is not limited by the present description of one or more embodiments, but rather, is defined by the spirit and scope of the claims attached hereto.

What is claimed is:

1. An apparatus for moving a load relative to a base structure, the apparatus comprising:
a motor adapted to be carried by the base structure, the motor having an output shaft; and
a constant tension spring having a first end and a second end, the first end attached to one of the base structure and the output shaft of the motor, the second end adapted to be attached to the panel to assist the motor in moving the load.

2. The apparatus of claim 1, further comprising a pulley fixed to the output shaft, the pulley having means to attach to the first end of the spring.

3. The apparatus of claim 2, wherein the first end of the spring comprises a tang extending at an angle from the innermost coil of the tape spring, the tang received in a generally radial slot of the pulley.

4. An apparatus for moving a load relative to a base structure, the apparatus comprising:
a motor adapted to be carried by the base structure, the motor having an output shaft driving a reel on which a cable is coiled, a first end of the cable attached to the reel and a second end of the cable attached to the load, which is partially resisted by a constant tension spring, a first end of the constant tension spring attached to the load, a second end of the constant tension spring being coiled and freely rotatable relative to, but otherwise constrained by, the base structure.

5. The apparatus of claim 4, further comprising an axle carried by the base structure, the axle carrying said spring.

6. An apparatus for selectively permitting the passage of pets, the apparatus comprising:
a base structure;
a panel carried by the base structure for movement between an open position and a closed position;
a motor carried by the base structure, the motor having an output shaft;
a constant tension spring having a first end and a second end, the first end of the spring attached to the output shaft of the motor, the second end attached to the panel, the spring biasing the panel into the open position; and
a control system in communication with the motor to actuate the motor and rotate the output shaft to move the panel from the closed position to the open position.

7. The apparatus of claim 6, further comprising a spring pulley fixed to the output shaft, the pulley having means to attach to the first end of the spring.

8. The apparatus of claim 7, wherein the first end of the spring comprises a tang extending at an angle from the innermost coil of the tape spring, the tang received in a generally radial slot of the pulley.

9. An apparatus for moving a panel relative to a base structure, the apparatus comprising:
a motor adapted to be carried by the base structure, the motor having an output shaft driving a reel on which a cable is coiled, a first end of the cable attached to the reel and a second end of the cable attached to the panel, which is partially resisted by a constant tension spring, a first end of the constant tension spring attached to the output shaft of the motor, a second end of the constant tension spring attached to the panel; and
a control system in communication with the motor to actuate the motor and rotate the output shaft to move the panel from a closed position to an open position.

10. The apparatus of claim 9, further comprising an axle carried by the base structure, the axle carrying said spring.

11. The apparatus of claim 6, further comprising an antenna in communication with the control system, the antenna carried by the panel.

12. The apparatus of claim 11, wherein the antenna comprises a radio frequency antenna operating at a frequency between approximately 90 KHz and approximately 200 KHz.

13. The apparatus of claim 6, wherein the base structure defines an opening slidably receiving the panel.

14. The apparatus of claim 13, wherein the base structure further comprises at least one groove disposed adjacent to the opening, the at least one groove partially retaining a seal.

15. The apparatus of claim 14, wherein the at least one groove comprises at least one generally T-shaped cross-sectional slot for retaining the seal.

16. A system for selectively permitting the passage of pets, the system comprising:
a frame;
a sliding door carried within the frame for movement between an open position and a closed position;
a motor carried by the frame, the motor having an output shaft;
a constant tension spring attached to the door, the spring biasing the door into the open position;
a control system in communication with the motor to actuate the motor and rotate the output shaft, thereby sliding the door from the closed position to the open position;
a radio frequency antenna carried by the door; and
at least one fob in communication with the antenna for signaling the control system to actuate the motor.

17. The system of claim 16, wherein said spring comprises a first end and a second end, the first end operably attached to the output shaft of the motor and the second end attached to the door.

18. The apparatus of claim 17, further comprising a pulley fixed to the output shaft, the pulley having means to attach to the first end of the spring.

19. The apparatus of claim 18, wherein the first end of said spring comprises a tang extending at an angle from the innermost coil of said spring, the tang received in a generally radial slot of the pulley.

20. The system of claim 16, further comprising an axle carried by the frame, and wherein the constant tension spring comprises a first end and a second end, the first end being freely rotatable about and axially restrained on the axle and the second end attached to the door.

21. The system of claim 20, further comprising a cable having a first end operably attached to a reel driven by the output shaft of the motor and a second end attached to the door.

22. The system of claim 16, wherein the at least one fob comprises a fob having a programmable microchip that is programmed in accordance with a code provided by the control system.

23. The apparatus of claim 16, wherein the frame defines an opening slidably receiving the panel.

24. The apparatus of claim 23, wherein the frame further comprises at least one groove disposed adjacent to the opening, the at least one groove retaining a seal.

25. The apparatus of claim 24, wherein the at least one groove comprises at least one generally T-shaped cross-sectional slot for retaining the seal.

26. The apparatus of claim 16, wherein the radio frequency antenna operates at a frequency between approximately 90 KHz and approximately 200 KHz.

27. An apparatus for selectively permitting the passage of pets, the apparatus comprising:
a frame;
a sliding door carried by the frame for movement between an open position and a closed position;
a motor carried by the frame and operably connected to the sliding door to move the sliding door into the open position from the closed position;
a control system in communication with the motor to actuate the motor, thereby sliding the door from the closed position to the open position; and
a radio frequency antenna carried by the door.

28. The apparatus of claim 27, wherein radio frequency antenna operates at a frequency that is between approximately 90 KHz and approximately 200 KHz.

29. The apparatus of claim 27, wherein radio frequency antenna operates at a frequency of approximately 134 KHz.

30. The apparatus of claim 27, further comprising a constant tension spring attached to the door, the spring biasing the door into the open position.

31. The apparatus of claim 30, wherein the spring is also operably connected to the motor to assist the motor in moving the door to the open position.

32. The apparatus of claim 30, further comprising an axle carried by the frame, and wherein the constant tension spring comprises a first end and a second end, the first end being freely rotatable about and axially restrained on the axle and the second end attached to the door.

33. The apparatus of claim 27, further comprising at least one fob in communication with the antenna for signaling the control system to actuate the motor.

34. The apparatus of claim 33, wherein the at least one fob comprises a fob having a programmable microchip that is programmed in accordance with a code provided by the control system.

35. The apparatus of claim 27, wherein the frame further comprises at least one groove disposed adjacent to the door, the at least one groove retaining a seal.

36. The apparatus of claim 35, wherein the at least one groove comprises at least one generally T-shaped cross-sectional slot for retaining the seal.

37. An apparatus for selectively permitting the passage of pets, the apparatus comprising:
a frame defining an opening
a sliding door carried within the opening for movement between an open position and a closed position;
a seal carried by the frame between the frame and the sliding door at least when the sliding door is in the closed position; and
a motor carried by the frame and operably connected to the sliding door to move the sliding door into the open position from the closed position.

38. The apparatus of claim 37, wherein the frame comprises a groove disposed adjacent to at least a portion of the opening.

39. The apparatus of claim 38, wherein the groove is adapted to accommodate at least a portion of the sliding door when the sliding door is in the closed position and the seal is disposed within the groove.

40. The apparatus of claim 39, wherein the groove comprises at least one slot for retaining the seal within the groove.

41. The apparatus of claim 40, wherein the slot comprises a generally T-shaped cross-section.

42. The apparatus of claim 41, wherein the groove comprises a plurality of slots and a plurality of seals, each of the plurality of seals retained in one of the plurality of slots.

43. The apparatus of claim 42, wherein each of the plurality of seals face in a different direction, for sealing against different surfaces of the sliding door.

44. The apparatus of claim 37, further comprising a constant tension spring connected to the door for biasing the door into the open position.

45. The apparatus of claim 44, wherein the spring is also operably connected to the motor for assisting the motor in moving the door into the open position.

46. The apparatus of claim 37, further comprising a radio frequency antenna carried by the panel and operating at a frequency between approximately 90 KHz and approximately 200 KHz.

47. A system for selectively permitting the passage of pets, the system comprising:
a frame;
a sliding door carried within the frame for movement between an open position and a closed position;
a motor carried by the frame, the motor having an output shaft;
a control system in communication with the motor to actuate the motor and rotate the output shaft, thereby sliding the door from the closed position to the open position; and
a radio frequency antenna carried by one of the frame and the door, the radio frequency antenna operating at a low frequency of between approximately 90 KHz and approximately 200 KHz.

48. The system of claim 47, wherein the radio frequency antenna operates at a frequency of approximately 134 KHz.

49. The system of claim 47, wherein the radio frequency antenna is laminated within the door.

50. The system of claim 47, further comprising a constant tension spring coupled between the motor and the panel for assisting the motor in raising the panel.

51. The system of claim 47, further comprising at least one fob in communication with the antenna for signaling the control system to actuate the motor.

52. The system of claim 51, wherein the fob comprises a programmable fob.
